(19) United States
(12) Patent Application Publication
(10) Pub. No.: US 2005/0212295 A1
(43) Pub. Date: Sep. 29, 2005

(54) A/C pipe containment cap and method

(76) Inventor: Steven K. Wolff, Mesa, AZ (US)

Correspondence Address: ROBERT A. PARSONS, 4000 N. CENTRAL AVENUE, SUITE 1220, PHOENIX, AZ, 85012, US

(21) Appl. No.: 11/085,765

(22) Filed: Mar. 21, 2005

Related U.S. Application Data
(60) Provisional application No. 60/557,009, filed on Mar. 26, 2004.

(51) Int. Cl. F16L 17/00

(52) U.S. Cl. 285/420

(57) ABSTRACT

A repaired pipeline includes an A/C pipe segment having an end, a repair segment having an end and a repair coupling coupling the A/C pipe segment to the repair segment. An A/C pipe containment cap includes an annular end having a width slightly larger than a thickness of the A/C pipe segment, an outer diameter side wall extending perpendicularly from an outer edge of the annular end, and an inner diameter side wall extending perpendicularly from an inner edge of the annular end. The containment cap is mounted on the end of the A/C pipe with the inner diameter side wall and the outer diameter sidewall extending longitudinally along an inside surface and an outside surface of the A/C pipe, respectively, and the annular end engaging the end of the A/C pipe.

### CROSS-REFERENCE TO RELATED APPLICATION

This application claims the benefit of U.S. Provisional Application No. 60/557,009, filed 26 Mar. 2004.

### FIELD OF THE INVENTION

This invention relates to water pipes.

More particularly, the present invention relates to A/C water main pipe repair.

### BACKGROUND OF THE INVENTION

Asbestos cement (A/C) pipe is a type of pipe that was prevalently used for the construction of water mains throughout the world before the hazardous effects of asbestos fibers were recognized. Due to their long employment, much of the superstructure of the water distribution system have some are many segments of A/C pipe. While the use of A/C pipe has been too extensive to permit replacement, there are hazards associated with its continued existence in the water system. Two particular concerns are addressed by the present invention.

Irregularities in an A/C pipe, such as fissures, cracks, breaks and the like, can result in erosion by the water flowing therethrough. Specifically, turbulence in the water flow will carry friable A/C material into the water supply. Asbestos fibers in the water may pose health concerns. Additionally, when an A/C pipe is damaged or broken, a repair segment of pipe must be installed. While the repair segment of pipe is typically not A/C pipe, it must be mated to the ends of the existing A/C pipe segments. During this repair process, workers are exposed to the A/C material presenting a possible health hazard to the workers.

It would be highly advantageous, therefore, to remedy the foregoing and other deficiencies inherent in the prior art.

Accordingly, it is an object of the present invention to provide a new and improved method and apparatus for repairing and working with A/C pipe.

Another object of the present invention is to provide a method and apparatus for containing A/C material during repairing of A/C pipe.

### SUMMARY OF THE INVENTION

Briefly, to achieve the desired objects of the present invention in accordance with a preferred embodiment thereof, provided is an A/C pipe containment cap for receipt on an end of an A/C pipe segment. The containment cap includes an annular end having a width slightly larger than a thickness of an A/C pipe to be capped, an outer diameter side wall extending perpendicularly from an outer edge of the annular end, and an inner diameter side wall extending perpendicularly from an inner edge of the annular end, substantially parallel and spaced from the outer diameter side wall. The cap is mountable on an end of an A/C pipe with the inner diameter side wall and the outer diameter sidewall extending longitudinally along an inside surface and an outside surface of the A/C pipe, respectively, and with the annular end engaging the end of the A/C pipe.

In a specific aspect, the A/C pipe containment cap includes a layer of pipe dope carried between the inner diameter side wall and the outer diameter sidewall, and substantially covering the annular end.

Also provided is a repaired pipeline including an A/C pipe segment having an end, a repair segment having an end, and an A/C pipe containment cap. The A/C pipe containment cap includes an annular end having a width slightly larger than a thickness of the A/C pipe segment, an outer diameter side wall extending perpendicularly from an outer edge of the annular end, and an inner diameter side wall extending perpendicularly from an inner edge of the annular end, substantially parallel and spaced from the outer diameter side wall. The containment cap is mounted on the end of the A/C pipe with the inner diameter side wall and the outer diameter sidewall extending longitudinally along an inside surface and an outside surface of the A/C pipe, respectively, and the annular end engaging the end of the A/C pipe. A repair coupling couples the A/C pipe segment to the repair segment.

Additionally, provided is a method of repairing a pipeline including the steps of providing an A/C pipe pipeline having an A/C pipe segment with an end, a repair segment having an end, and an A/C pipe containment cap. The containment cap is mounted onto the end of the A/C pipe segment with the inner diameter side wall and the outer diameter sidewall extending longitudinally along an inside surface and an outside surface of the A/C pipe segment, respectively, the annular end engaging the end of the A/C pipe segment. The A/C pipe segment is coupled to the repair segment with a repair coupling.

In a further aspect of the method, the step of providing an A/C pipe containment cap includes placing a layer of pipe dope in the A/C pipe containment cap between the inner diameter side wall and the outer diameter sidewall, and substantially covering the annular end.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a perspective view of a repair coupling on an A/C pipe;

FIG. 2 is an exploded view of the pipe segments and containment cap according to the present invention;

FIG. 3 is a perspective view of the containment cap of FIG. 2; and

FIG. 4 is a sectional view taken along line 4-4 of FIG. 3.

### DETAILED DESCRIPTION OF THE PREFERRED EMBODIMENT

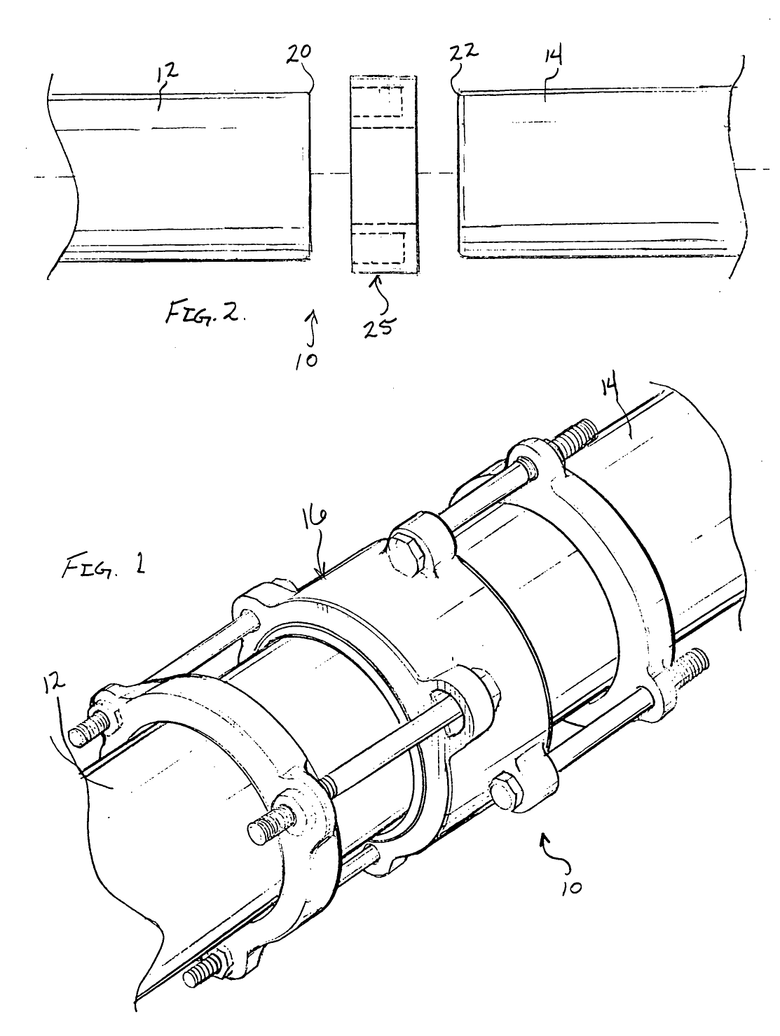

Turning now to the drawings in which like reference characters indicate corresponding elements throughout the several views, attention is first directed to FIG. 1 which illustrates a repaired pipe line generally designated 10. Line 10 includes a segment of A/C pipe 12, a repair segment 14, and a repair coupling 16. Repair coupling 16 is known in the art and can be substantially any fitting used to coupled two pipe segments together. As a specific example, repair coupling 16 is illustrated as a repair coupling style RR501 available from Romac Industries, Inc.

Referring to FIG. 2, an exploded view of repaired pipe line 10 with repair coupling 16 removed is illustrated. A/C pipe 12 includes an end 20 which has been created by snapping. Due to the nature of A/C pipe, namely the inclusion of asbestos fibers, grinding or cutting is prohibited to reduce the release of asbestos fibers. To prepare A/C pipe 12, end 20 is created by snapping. Exposed end 20 still presents a problem as snapping can leave friable material presenting a potential hazard to the worker. Additionally, when repair is completed, end 20 will be exposed to the eroding properties of the water flowing through pipe line 10 resulting in asbestos entering the water supply. Repair segment 14 includes an end 22, and typically an opposing end which will be coupled to an opposing segment of A/C pipe (not shown). To reduce or eliminate the hazards present, an A/C pipe containment cap 25 is coupled to end 20 of A/C pipe 12.

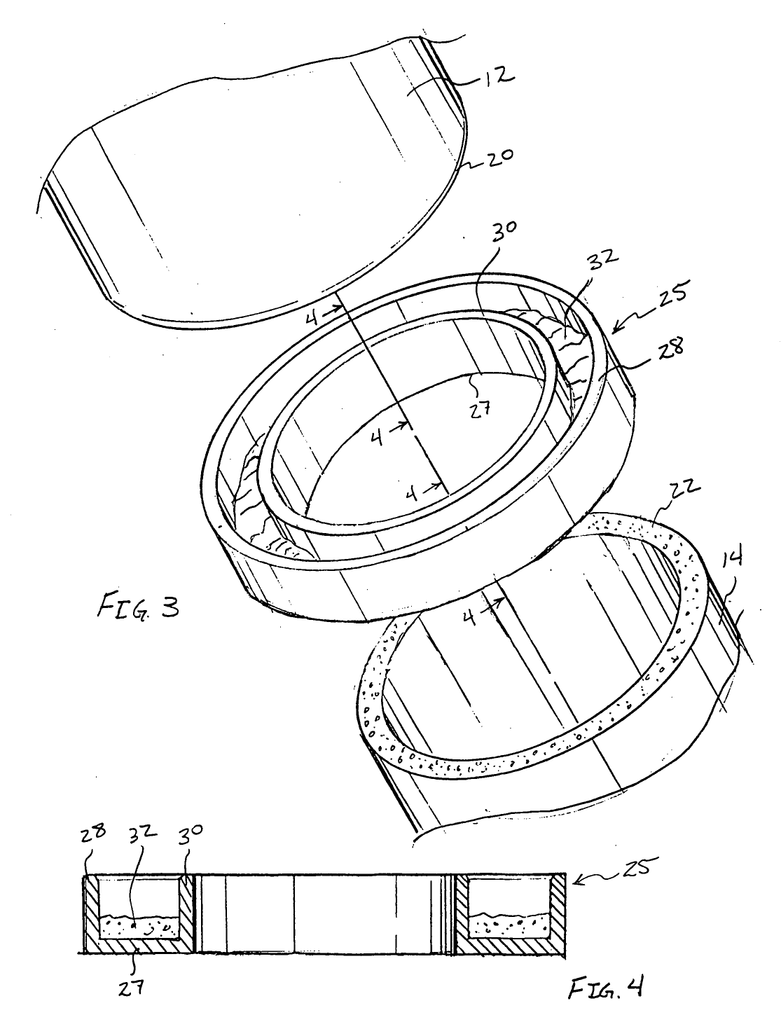

With additional reference to FIGS. 3 and 4, containment cap 25 includes an annular end 27 having a width slightly larger than the thickness of A/C pipe 12. An outer diameter side wall 28 extends perpendicularly from an outer edge of end 27, and an inner diameter side wall 30 extends perpendicularly from an inner edge of end 27, substantially parallel and spaced from outer diameter side wall 28. While cap 25 can be fabricated of substantially any material, the preferred material is high density polyethylene (HDPE) or any NSF-61 approved material. A layer 32 of pipe dope is carried within cap 25 between side walls 28 and 30, and substantially covering end 27. Any pipe dope can be employed, but it is preferred that a National Sanitation Foundation (NSF) approved pipe dope be employed. When positioned on end 20 of A/C segment 12, side walls 28 and 30 extend longitudinally along the outside and inside thereof, with end 27 engaging end 20. Layer 32 of pipe dope engulfs end 20 holding cap 25 in position, and preventing any friable portions of A/C pipe from escaping to the environment. Thus, a hazard to the workers is removed. Continued work on the repairs to pipe line 10 can be accomplished without the hazard of asbestos fibers entering the environment. Additionally, when repair of pipe line 10 is completed, containment cap 25 prevents water flow from eroding end 20 and any friable portions of A/C pipe 12 are prevented from entering the water supply because they are entrapped by the pipe dope.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. An A/C pipe containment cap for receipt on an end of an A/C pipe segment, the cap comprising:
an annular end having a width slightly larger than a thickness of an A/C pipe to be capped;
an outer diameter side wall extending perpendicularly from an outer edge of the annular end; and
an inner diameter side wall extending perpendicularly from an inner edge of the annular end, substantially parallel and spaced from the outer diameter side wall;
wherein the cap is mountable on an end of an A/C pipe with the inner diameter side wall and the outer diameter sidewall extending longitudinally along an inside surface and an outside surface of the A/C pipe, respectively, and with the annular end engaging the end of the A/C pipe.

2. An A/C pipe containment cap as claimed in claim 1 further including a layer of pipe dope carried between the inner diameter side wall and the outer diameter sidewall, and substantially covering the annular end.

3. An A/C pipe containment cap as claimed in claim 2 wherein the pipe dope is a National Sanitation Foundation (NSF) approved pipe dope.

4. An A/C pipe containment cap as claimed in claim 1 wherein the containment cap is fabricated of high density polyethylene.

5. An A/C pipe containment cap as claimed in claim 1 wherein the containment cap is fabricated of NSF-61 approved material.

6. A repaired pipeline comprising:
an A/C pipe segment having an end;
a repair segment having an end;
an A/C pipe containment cap including an annular end having a width slightly larger than a thickness of the A/C pipe segment, an outer diameter side wall extending perpendicularly from an outer edge of the annular end, and an inner diameter side wall extending perpendicularly from an inner edge of the annular end, substantially parallel and spaced from the outer diameter side wall;
the containment cap mounted on the end of the A/C pipe with the inner diameter side wall and the outer diameter sidewall extending longitudinally along an inside surface and an outside surface of the A/C pipe, respectively, and the annular end engaging the end of the A/C pipe; and
a repair coupling coupling the A/C pipe segment to the repair segment.

7. A repaired pipeline as claimed in claim 6 further including a layer of pipe dope carried between the inner diameter side wall and the outer diameter sidewall of the containment cap, and substantially covering the annular end.

8. A repaired pipeline as claimed in claim 7 wherein the layer of pipe dope engulfs the end of the A/C pipe segment holding the containment cap in position, and preventing any friable portions of the A/C pipe from escaping to the environment.

9. A repaired pipeline as claimed in claim 7 wherein the pipe dope is a National Sanitation Foundation (NSF) approved pipe dope.

10. A repaired pipeline as claimed in claim 6 wherein the containment cap is fabricated of high density polyethylene.

11. A repaired pipeline as claimed in claim 6 wherein the containment cap is fabricated of NSF-61 approved material.

12. A method of repairing a pipeline comprising the steps of:
providing an A/C pipe pipeline having an A/C pipe segment with an end;
providing a repair segment having an end;
providing an A/C pipe containment cap including an annular end having a width slightly larger than a thickness of the A/C pipe segment, an outer diameter side wall extending perpendicularly from an outer edge of the annular end, and an inner diameter side wall extending perpendicularly from an inner edge of the annular end, substantially parallel and spaced from the outer diameter side wall;
mounting the containment cap onto the end of the A/C pipe segment with the inner diameter side wall and the outer diameter sidewall extending longitudinally along an inside surface and an outside surface of the A/C pipe segment, respectively, the annular end engaging the end of the A/C pipe segment; and
coupling the A/C pipe segment to the repair segment with a repair coupling.

13. A method as claimed in claim 12 wherein the step of providing the A/C pipe segment with an end includes snapping the pipe segment to create the end.

14. A method as claimed in claim 12 wherein the step of providing an A/C pipe containment cap includes placing a layer of pipe dope in the A/C pipe containment cap between the inner diameter side wall and the outer diameter sidewall, and substantially covering the annular end.

15. A method as claimed in claim 14 wherein the step of mounting the containment cap onto the end of the A/C pipe segment includes engulfing the end of the A/C pipe segment in the layer of pipe dope thereby holding the containment cap in position and preventing any friable portions of the A/C pipe from escaping to the environment.
